(19) United States
(12) Patent Application Publication
(10) Pub. No.: US 2023/0009195 A1
(43) Pub. Date: Jan. 12, 2023

(54) PREVENTION APPARATUS OF USER REQUIREMENT VIOLATION FOR CLOUD SERVICE, PREVENTION METHOD OF USER REQUIREMENT VIOLATION AND PROGRAM THEREOF

(71) Applicant: NIPPON TELEGRAPH AND TELEPHONE CORPORATION, Tokyo (JP)

(72) Inventors: Chao WU, Musashino-shi, Tokyo (JP); Shingo HORIUCHI, Musashino-shi, Tokyo (JP); Kenichi TAYAMA, Musashino-shi, Tokyo (JP)

(73) Assignee: NIPPON TELEGRAPH AND TELEPHONE CORPORATION, Tokyo (JP)

(21) Appl. No.: 17/783,312

(22) PCT Filed: Dec. 9, 2019
(86) PCT No.: PCT/JP2019/048025

§ 371 Date: Jun. 8, 2022

(51) Int. Cl. G06F 9/50; G06N 20/20

(52) U.S. Cl. CPC G06F 9/5005; G06N 20/20; G06F 2209/501

(57) ABSTRACT

A ratio of prediction liable to result in user requirement violation is reduced by adjusting results of resource design even if it is highly likely that the user requirement violation will incur a heavy penalty. There is provided a requirement specifying functional unit (11) that specifies a user requirement for a service of interest, and a resource design unit (12) that predicts, by machine learning, performance achievable at a plurality of resource settings in performing the service of interest and selects a resource setting that satisfies the specified user requirement, based on results of the prediction, wherein the resource design unit (12) generates a P model as a model for use to predict performance, the P model using a P-mode loss function obtained by adding a function to an N model that uses an existing N-mode loss function, the added function taking a finite value when actual performance is lower than predicted performance.

### TECHNICAL FIELD

The present invention relates to a prevention apparatus of user requirement violation for cloud service, a prevention method of user requirement violation and a program thereof

### BACKGROUND ART

In cloud service and virtual network function (VNF) that perform various information processing via cloud computing, there is demand for a technique for automatically carrying out resource design according to user requirements, and in particular, according to processing loads (workloads) and performance requirements (e.g., Non-Patent Literature 1).

### CITATION LIST

### Non-Patent Literature

Non-Patent Literature 1: ’Wu Chao and Shingo Horiuchi, “Intent-based Cloud Service Management”, ICIN 2018, Paris, France, February 2018.

### SUMMARY OF THE INVENTION

### Technical Problem

When cloud resources are designed automatically according to user requirements in providing cloud services, even if penalties for violation of user requirements are different, resource design results cannot be adjusted. This means that the risk of user requirement violation cannot be adjusted and even if penalties for violation of user requirements are heavy in particular, the risk of violation cannot be reduced, which might result in profit losses and the like.

The present invention has been made in view of the above circumstances and has an object to provide a prevention apparatus of user requirement violation for cloud service, a prevention method of user requirement violation and a program thereof, that can reduce the ratio of prediction liable to result in user requirement violation by adjusting results of resource design even if it is highly likely that the user requirement violation will incur a heavy penalty.

### Means for Solving the Problem

According to one aspect of the present invention, there is provided a requirement specifying functional unit that specifies a user requirement for a service of interest; and a resource design unit that predicts, by machine learning, performance achievable at a plurality of resource settings in performing the service of interest and selects a resource setting that satisfies the user requirement specified by the requirement specifying functional unit, based on results of the prediction, wherein the resource design unit generates a second model as a model for use to predict performance, the second model using a second loss function obtained by adding a function to a first model that uses an existing first loss function, the added function taking a finite value when actual performance is lower than predicted performance.

### Effects of the Invention

According to one aspect of the present invention, it is possible to reduce the ratio of prediction liable to result in user requirement violation by adjusting results of resource design even if it is highly likely that the user requirement violation will incur a heavy penalty.

### BRIEF DESCRIPTION OF THE DRAWINGS

FIG. 1 is a block diagram showing a schematic functional configuration of a resource design apparatus according to an embodiment of the present invention.

FIG. 2 is a flowchart showing process details of how an N model and a P model are generated by a model generation unit according to the embodiment.

FIG. 3 is a flowchart showing process details of performance prediction carried out by a prediction unit according to the embodiment.

FIG. 4 is a diagram showing, in parallel, SLA violation risks VR of a P model and N model according to the embodiment.

FIG. 5 is a diagram showing, in parallel, performance prediction accuracies MAPE of the P model and N model according to the embodiment.

FIG. 6 is a diagram numerically showing results of FIG. 4 and FIG. 5 together according to the embodiment.

### DESCRIPTION OF EMBODIMENTS

Description will be given below of an embodiment resulting from application of the present invention to a resource design apparatus incorporated as part of a system that provides services via cloud computing.

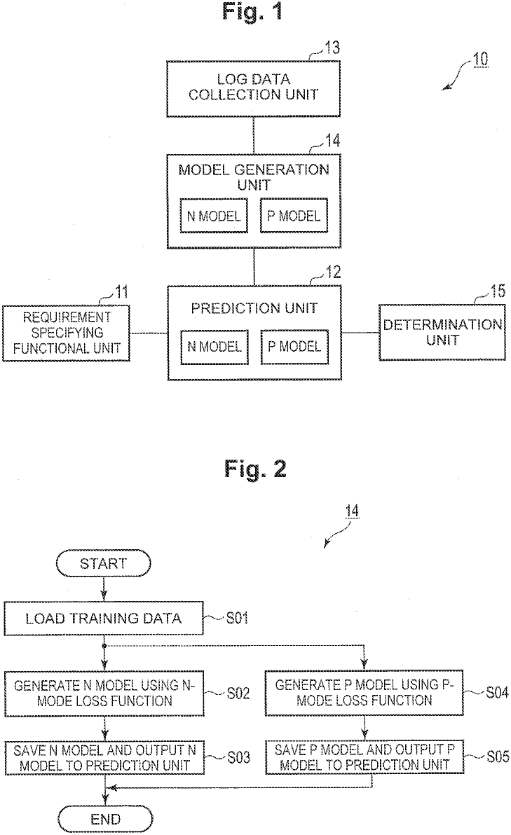

FIG. 1 is a block diagram showing a schematic functional configuration of the resource design apparatus 10. In FIG. 1, the resource design apparatus 10 includes a requirement specifying functional unit 11, a prediction unit 12, a log data collection unit 13, a model generation unit 14, and a determination unit 15.

In response to operation of cloud service users (hereinafter referred to as the “user”) including the resource design apparatus 10, the requirement specifying functional unit 11 collects requirements for services, outputs user requirements to the prediction unit 12, receives and displays resource design results obtained from the prediction unit 12, and gives implementation instructions.

More specifically, as a user requirement, the requirement specifying functional unit 11 specifies an amount or characteristics of workload to be processed and a permissible performance resource design apparatus mode (N mode or P mode).

As a performance prediction model, the resource design apparatus 10 can be set to either N mode (normal mode) or P mode (protection mode, which is lower in SLA violation risk than the N mode under similar conditions). A cloud service system operator (hereinafter referred to as a “system administrator”) or user who operates the resource design apparatus 10 specifies the P mode or the N mode according to a penalty for SLA violation. The system administrator or the user specifies at least one of an N model and a P model, where the N model uses an N-mode loss function, which is an existing function, while the P model uses a P-mode loss function obtained by adding a function that takes a finite value when actual performance of the service is lower than predicted performance in response to the user requirement.

When specifying a performance prediction model of the P model using the P-mode loss function in addition, the system administrator or the user specifies a definition of a penalty for user requirement violation, the definition being used in the P-mode loss function.

The log data collection unit 13 collects log data of performance under applicable conditions by varying, with respect to a conceivable task of an applicable cloud application, a machine learning model configuration and resources placed according to throughput, and performs reformatting, integration, preprocessing, and the like.

The log data is sent out as data for model training from the log data collection unit 13 to the model generation unit 14.

When processing workload specified by the user via the requirement specifying functional unit 11 using the log data from the log data collection unit 12A as model training data, the model generation unit 14 generates performance prediction models of the N model and P model for predicting performance achievable under applicable resource setting conditions and sends out the generated models to the prediction unit 12.

Using the performance prediction models of the N model and P model generated by the model generation unit 14, the prediction unit 12 predicts performances achievable under applicable resource setting conditions in handling specified throughput (workload) and sends out prediction results to the determination unit 15.

The determination unit 15 collectively select resource settings that can satisfy user-specified requirements, as resource design results, from the performance prediction results obtained from the prediction unit 12.

Next, operation of the present embodiment will be described.

Upon receiving user requirements specified by the requirement specifying functional unit 11, the model generation unit 14 generates an N model and P model for predicting performance in N mode and P mode.

Here, generation of the N model and P model uses different loss functions described below and consequently allows different prediction trends to be implemented.

An N-model loss function used for the N model is an existing loss function, such as an MAPE (Mean Absolute Percentage Error) or MAE (Mean Absolute Error) function, which does not have a prediction bias adjustment effect. In other words, this means that the probability that actual performance is better than predicted performance is equal to the probability that the actual performance is worse than the predicted performance. For example, if MAPE is used, a loss function L of MAPE is given by the following expression.

$$L = \frac{\sum {}_{i = 1}^{N} ( \frac{\vert p f {m}_{i} - {{p f m}^{⏜}}_{i} \vert}{p f {m}_{i}} )}{N}$$

In the above expression, N is the number of training data items used to generate a model, “pfmᵢ” is actual performance in the i-th training data item, and “pfmi” with an umbrella-shaped symbol put on the “pfm” portion is predicted performance for the i-th training data item.

That is, for each training data item, the absolute value of the difference obtained by subtracting the predicted performance from the actual performance is divided by the actual performance, and the resulting quotient is used as a relative error of training data; and then the sum total of the first to the n-th relative errors of the training data is found and the average value obtained by dividing the sum total by the number N of training data items is designated as the loss function L.

A P-model loss function Lₚ used for the P model is given by the following expression.

$${L}_{p} = \frac{\sum {}_{i = i}^{N} ( \frac{\vert p f {m}_{i} - \hat{p f m} {}_{i} \vert}{p f {m}_{i}} + w \times P )}{N}$$

The P-model loss function Lₚ is found as follows: for the above-described N-model loss function L, addition of a penalty “w × P” for user requirement violation to each i-th relative error is made for the first to the n-th relative errors of the training data and the sum total thereof is obtained, and the average value is found by dividing the sum total by the number N of training data items.

By adding the penalty “w × P” for user requirement violation to the N-mode loss function L in this way, the P-model loss function Lₚ converges in such a direction as to minimize a prediction error and the penalty “w × P” for user requirement violation when the model generation unit 14 generates a model. Therefore, the penalty “w × P” for user requirement violation serves as a function that takes a finite value for the N-model loss function L.

The penalty “w × P” for user requirement violation is entered and specified as a setting that defines a penalty at the same time as the user specifies the P mode via the requirement specifying functional unit 11, where “w” may be set as any of various constants and “P” can be set using any of various functions as described below.

Two examples P1 and P2 of P will be cited below.

$$P 1 = \left\{\begin{matrix}\frac{\vert p f {m}_{i} - {\hat{p f m}}_{i} \vert}{p f {m}_{i}} , i f p f {m}_{i} i s w o r s e \text{} t h a n {\hat{p f m}}_{i} \\ 0 , i f p f {m}_{i} i s b e t t e r t h a n {\hat{p f m}}_{i}\end{matrix}\right.$$

$$P 2 = \left\{\begin{matrix}1 , i f p f {m}_{i} i s w o r s e t h a n {\hat{p f m}}_{i} \\ 0 , i f p f {m}_{i} i s b e t t e r t h a n {\hat{p f m}}_{i}\end{matrix}\right.$$

In the above expression, P1 is an example in which a percentage difference (relative error) is given as a penalty when the actual performance is worse than the predicted performance and no penalty is given otherwise.

In the above expression, P2 is an example in which a constant 1 is given as a penalty when the actual performance is worse than the predicted performance and no penalty is given otherwise.

FIG. 2 is a flowchart showing process details of how an N model and a P model are generated by the model generation unit 14.

First, the model generation unit 14 reads training data out of the log data collection unit 13 (step S01) .

Based on the read training data, the model generation unit 14 performs an N-model generation process using the N-mode loss function L described above (step S02). Then, the model generation unit 14 saves the generated N model and outputs the N generated model to the prediction unit 12 (step S03).

In parallel with the processes of steps S02 and S03, the model generation unit 14 performs a P-model generation process using the P-mode loss function Lₚ described above based on the read training data (step S04). Then, the model generation unit 14 saves the generated P model and outputs the generated P model to the prediction unit 12 (step S05).

When the processes of both step S03 and step S05 are finished, the model generation unit 14 finishes the model generation process once.

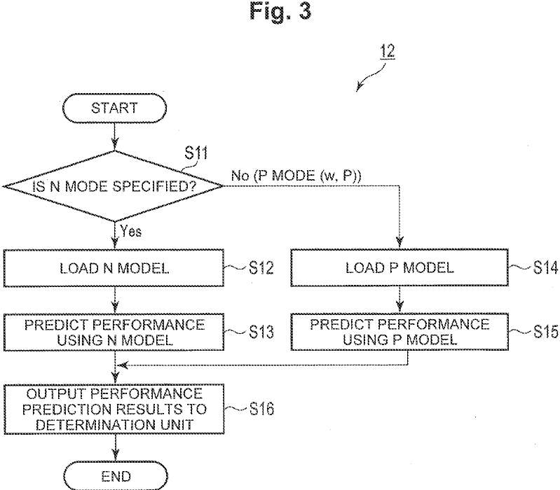

FIG. 3 is a flowchart showing details of a process carried out by the prediction unit 12 when the prediction unit 12 is specified to selectively carry out performance prediction of one of an N model and a P model.

First, the prediction unit 12 determines which of the N mode and the P mode has been specified, based on whether the performance prediction mode specified by the user or the system administrator is the N mode (step S11) .

If it is determined that N-mode performance prediction has been specified (Yes in step S11), the prediction unit 12 reads an N model (step S12) and performs a performance prediction process using the read N model (step S13).

The prediction unit 12 outputs the acquired N-model performance prediction results to the determination unit 15 (step S16) and thereby finishes the performance prediction process once.

If it is determined in step S11 that rather than N mode, P-model performance prediction including the penalty “w × P” for user requirement violation has been specified (No in step S11), the prediction unit 12 reads the P model (step S14) and performs a performance prediction process using the read P model (step S15).

The prediction unit 12 outputs the acquired P-model performance prediction results to the determination unit 15 (step S16) and thereby finishes the performance prediction process once.

Note that in the process of FIG. 3, description has been given of operation performed by the prediction unit 12 when performance prediction of one of an N model and a P model has been specified selectively. Besides, when performance prediction of both N model and P model has been specified, the prediction unit 12 performs the processes of steps S12 and S13 in parallel with the processes of steps S14 and S15 and outputs prediction results on performances of the N model and P model collectively to the determination unit 15 in step S16.

To assess a user requirement violation prevention effect, the determination unit 15 uses a user requirement violation index VR shown below.

$$V R = \frac{{\sum }_{j = 1}^{M} {V}_{j}}{M} ,$$

$${V}_{j} = \left\{\begin{matrix}1 , \text{if} e x c u t i m {e}_{j} > {\hat{e x c u t i m e}}_{j} \\ 0 , \text{if} e x c u t i m {e}_{j} \leq {\hat{e x c u t i m e}}_{j}\end{matrix}\right.$$

The user requirement violation risk index VR represents the ratio of the number of predictions liable to result in user requirement violation in making M performance predictions, and the larger the value of VR, the more liable a user requirement violation is to occur.

Description will be given below of an implementation example in which a risk assessment of user requirement violation is conducted in performance prediction of an N model and P model.

Here, in a machine learning service of MLaaS (Machine Learning as a Service) carried out on the resource design apparatus 10, results of training each of an N model and a P model were tuned using 23,046 sets of log data.

In the present embodiment, execution time prediction errors and user requirement violation risks were assessed in P mode and N mode using 5-fold cross-validation (training data : validation data = 80% : 20%).

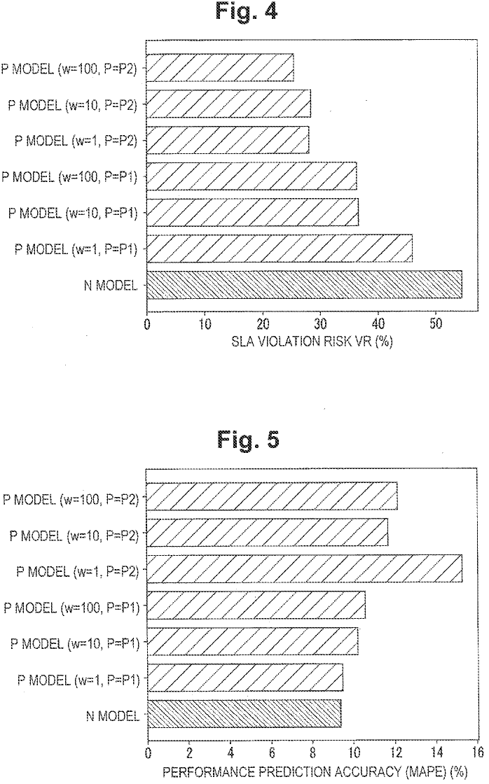

FIG. 4 is a diagram showing, in parallel, SLA violation risks VR of a P model and an N model in which various values of w and P are implemented (w = 1, 10, 100; P = P1, P2 (see Math. 3)).

Here, the value of SLA violation risk VR of the P model is the smallest when w = 100 and P = P2. As illustrated in FIG. 4, the P model can reduce the user requirement violation risk VR more than the N model can. In addition, it can be seen that with the P model, the user can adjust the user requirement violation risk VR as desired by varying w and P.

FIG. 5 is a diagram showing, in parallel, performance prediction accuracies MAPE of the P model and N model in which various values of w and P are similarly implemented (w = 1, 10, 100; P = P1, P2 (see Math. 3)).

Here, the value of performance prediction accuracy of the P model is the largest when w = 1 and P = P2. As illustrated, whereas the P model can reduce the user requirement violation risk more than the N model can, the performance prediction accuracy may change slightly.

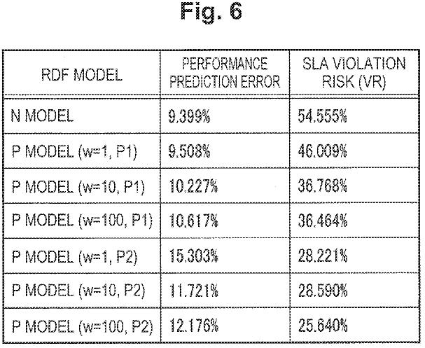

FIG. 6 is a diagram numerically showing results of FIG. 4 and FIG. 5 together.

In actual operation, the N mode or the P mode is select depending on the extent of the penalty for user requirement violation by taking a trade-off between violation risk and prediction accuracy into consideration, and when the P model is selected, w and P are set appropriately.

As described in detail above, the present embodiment makes it possible to reduce the ratio of prediction liable to result in user requirement violation by adjusting results of resource design even if it is highly likely that the user requirement violation will incur a heavy penalty.

Since the present embodiment allows the user to give specifications as desired in order to define the penalty “w × P” in the P-mode loss function used in machine learning performance prediction of the P model, a selection can be made in such a way as to avoid user requirement violation whenever possible.

Furthermore, since the present embodiment allows the system administrator or the user to selectively specify at least one of the N-mode and P-mode performance prediction models, a performance prediction model that uses a loss function suited to circumstances can be selected appropriately.

The apparatus according to the present invention can also be implemented by a computer and program, and the program can be either recorded on the recording medium or provided via a network.

Besides, the present invention is not limited to the embodiment described above, and may be modified in various forms in the implementation stage without departing from the gist of the invention. The above embodiment includes inventions in various stages, and various inventions can be extracted through appropriate combinations of the disclosed components. For example, even if some of all the components shown in the embodiment are removed, the resulting configuration can be extracted as an invention as long as the configuration can solve the problem described in Technical Problem and provide the effects described in Effects of the Invention.

### REFERENCE SIGNS LIST

10 Resource design apparatus
11 Requirement specifying functional unit
12 Prediction unit
13 Log data collection unit
14 Model generation unit
15 Determination unit

1. A prevention apparatus of user requirement violation for cloud service, the apparatus comprising:
a requirement specifying functional unit that specifies a user requirement for a service of interest; and
a resource design unit that predicts, by machine learning, performance achievable at a plurality of resource settings in performing the service of interest and selects a resource setting that satisfies the user requirement specified by the requirement specifying functional unit, based on results of the prediction, wherein
the resource design unit generates a second model as a model for use to predict performance, the second model using a second loss function obtained by adding a function to an existing first loss function of a first model that uses the existing first loss function, the added function taking a finite value when actual performance is lower than predicted performance.

2. The prevention apparatus of user requirement violation for cloud service according to claim 1, wherein the requirement specifying functional unit specifies a definition of the function that takes a finite value.

3. The prevention apparatus of user requirement violation for cloud service according to claim 1, wherein:
the requirement specifying functional unit specifies at least one of the first model and the second model to be generated; and
the resource design unit predicts achievable performance by machine learning, based on at least one of the first model and the second model specified by the requirement specifying functional unit.

4. A prevention method of user requirement violation for cloud service, the method comprising:
a requirement specifying function step of specifying a user requirement for a service of interest; and
a resource design step of predicting, by machine learning, performance achievable at a plurality of resource settings in performing the service of interest and selecting a resource setting that satisfies the user requirement specified in the requirement specifying function step, based on results of the prediction, wherein
the resource design step includes generating a second model as a model for use to predict performance, the second model using a second loss function obtained by adding a function to an existing first loss function of a first model that uses the existing first loss function, the added function taking a finite value when actual performance is lower than predicted performance.

5. A non-transitory computer-readable storage medium having a program stored thereon which program that causes a processor of the prevention apparatus of user requirement violation for cloud service according to claim 1, to perform processes of components of the prevention apparatus of user requirement violation for cloud service.
